(19) United States
(12) Patent Application Publication
(10) Pub. No.: US 2026/0048758 A1
(43) Pub. Date: Feb. 19, 2026

(54) CAMERA MONITOR SYSTEM WITH DRIVER DISPLAY FUNCTIONALITY

(71) Applicant: Stoneridge Electronics AB, Solna (SE)

(72) Inventors: Banuprakash Murthy, Novi, MI (US); Huimin Mattmuller, Rochester Hills, MI (US); Girikrishna Talla, Novi, MI (US)

(21) Appl. No.: 18/807,051

(22) Filed: Aug. 16, 2024

(51) Int. Cl. B60W 50/14; B60W 30/08; B60W 40/06

(52) U.S. Cl. CPC B60W 50/14; B60W 2050/143; B60W 2050/146; B60W 2420/403

(57) ABSTRACT

A method of providing views in a camera monitor system (CMS) for a vehicle include a) depicting vehicle operating information from a first controller onto a driver information display (DIS), the depicting step includes showing at least one of a vehicle speed, an engine rotational speed, fuel level, engine temperature, and gear position indicator, b) capturing an image from a field of view and providing the captured image to a second controller, c) detecting a triggering event relating to the captured image, d) sending the captured image from the second controller to the first controller in response to the triggering event, and e) altering the depicted vehicle operating information on the DIS with the first controller to show the captured image.

### TECHNICAL FIELD

This disclosure relates to a camera monitor system (CMS), and more particularly, to a method and apparatus for integrated a CMS with a driver information display (DIS).

### BACKGROUND

Vehicle camera systems for mirror replacement or for supplementing mirror views are utilized in commercial vehicles to enhance the ability of a vehicle operator to see a surrounding environment of the commercial vehicle. Camera monitor systems (CMS) utilize one or more cameras to provide an enhanced field of view to a vehicle operator. In some examples, the mirror replacement systems cover a larger field of view than a conventional mirror, or include views that are not fully obtainable via a conventional mirror.

There is a desire to improve operator visibility to reduce risk. One approach is to add more cameras and more displays to increase the viewable area around the vehicle. The number of displays may proliferate in a CMS as more cameras are added and more information is provided to the operator, which may make assimilating the information more challenging. While this approach may reduce blind spots, the operator is required to manage more information making it difficult fully take advantage of additional displayed views.

### SUMMARY

In one example embodiment, a method of providing views in a camera monitor system (CMS) for a vehicle include a) depicting vehicle operating information from a first controller onto a driver information display (DIS), the depicting step includes showing at least one of a vehicle speed, an engine rotational speed, fuel level, engine temperature, and gear position indicator, b) capturing an image from a field of view and providing the captured image to a second controller, c) detecting a triggering event relating to the captured image, d) sending the captured image from the second controller to the first controller in response to the triggering event, and e) altering the depicted vehicle operating information on the DIS with the first controller to show the captured image.

In a further example embodiment of any of the foregoing embodiments, the DIS has multiple display areas that are configured to depict the vehicle operating information, and the altering step swaps the captured image for the depicted vehicle operating information in at least one of the multiple display areas.

In a further example embodiment of any of the foregoing embodiments, the multiple display areas are arranged laterally on the DIS, and the altering step includes swapping the captured image for the at least one of the multiple display areas associated with a vehicle side from which the captured image originates.

In a further example embodiment of any of the foregoing embodiments, the first and second controllers are each domain controllers that are connected to a vehicle data bus, and the first and second controllers are connected to one another by a cable other than the vehicle data bus which communicates video data that includes the captured image.

In a further example embodiment of any of the foregoing embodiments, the detecting step includes one of the first and second controllers receiving the triggering event over the vehicle data bus.

In a further example embodiment of any of the foregoing embodiments, the triggering event includes a transmission gear position, and the captured image provides a rearward view from a trailer camera in communication with the second controller.

In a further example embodiment of any of the foregoing embodiments, the triggering event includes a turn signal indicator status from one side of a vehicle, and the captured image provides rearward view from a tractor camera on the one side. The tractor camera is in communication with the second controller.

In a further example embodiment of any of the foregoing embodiments, the triggering event includes detecting at least one of a vulnerable road user (VRU) and a non-VRU in the field of view, and the altering step includes showing the captured image having the at least one VRU and non-VRU.

In another exemplary embodiment, a camera monitor system (CMS), includes a driver information display (DIS) that has a first controller and configured to depict vehicle driver information that shows at least one of a vehicle speed, an engine rotational speed, fuel level, engine temperature, and gear position indicator, multiple cameras that are configured to capture multiple fields of view in proximity to a commercial vehicle, at least one of the multiple fields of view include a captured image, multiple displays other than the DIS that are configured to display images from the captured multiple fields of view, the multiple displays are configured to each illustrate a displayed field of view from the multiple fields of view, a second controller that is in communication with the multiple cameras and the multiple displays, the second controller is configured to send the captured image to the first controller in response to a triggering event that relates to the captured image, and the first controller is configured to alter the depicted vehicle operating information on the DIS to show the captured image.

In a further example embodiment of any of the foregoing embodiments, the DIS has multiple display areas that are configured to depict the vehicle operating information, and the second controller is configured to alter the depicted vehicle operating information by swapping the captured image for the depicted vehicle operating information in at least one of the multiple display areas. The multiple display areas are arranged laterally on the DIS, and the altering step includes swapping the captured image for the at least one of the multiple display areas associated with a vehicle side from which the captured image originates.

In a further example embodiment of any of the foregoing embodiments, the first and second controllers are each domain controllers that are connected to a vehicle data bus, and the first and second controllers are connected to one another by a cable other than the vehicle data bus which communicates video data that includes the captured image.

In a further example embodiment of any of the foregoing embodiments, one of the first and second controllers are configured to receive the triggering event over the vehicle data bus.

In a further example embodiment of any of the foregoing embodiments, the triggering event includes a transmission gear position, the multiple cameras include a trailer camera, and the captured image provides a rearward view from the trailer camera.

In a further example embodiment of any of the foregoing embodiments, the triggering event includes a turn signal indicator status from one side of a vehicle, the multiple cameras include a tractor camera and the captured image provides rearward view from the tractor camera on the one side.

In a further example embodiment of any of the foregoing embodiments, the triggering event includes detecting at least one of a vulnerable road user (VRU) and a non-VRU in the field of view, and the altering step includes showing the captured image having the at least one VRU and non-VRU.

In another example embodiment, a method of providing views in a camera monitor system (CMS) for a vehicle includes a) depicting vehicle operating information onto a driver information display (DIS), the depicting step includes showing at least one of a vehicle speed and an engine rotational speed, b) capturing an image from a field of view, c) detecting a triggering event relating to the captured image, and d) altering the depicted vehicle operating information on the DIS to show the captured image.

In a further example embodiment of any of the foregoing embodiments, the DIS has multiple display areas that are configured to depict the vehicle operating information, and the altering step swaps the captured image for the depicted vehicle operating information in at least one of the multiple display areas. The multiple display areas are arranged laterally on the DIS, and the altering step includes swapping the captured image for the at least one of the multiple display areas associated with a vehicle side from which the captured image originates.

In a further example embodiment of any of the foregoing embodiments, the triggering event includes a transmission gear position, and the captured image provides a rearward view from a trailer camera.

In a further example embodiment of any of the foregoing embodiments, the triggering event includes a turn signal indicator status from one side of a vehicle, and the captured image provides rearward view from a tractor camera on the one side.

In a further example embodiment of any of the foregoing embodiments, the triggering event includes detecting at least one of a vulnerable road user (VRU) and a non-VRU in the field of view, and the altering step includes showing the captured image having the at least one VRU and non-VRU.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a schematic front view of a commercial truck with a camera mirror system (CMS) used to provide at least narrow and wide fields of view alongside the vehicle (e.g., Class II and Class IV views).

FIG. 2 is a schematic birds-eye view of the commercial truck of FIG. 1 with a CMS providing, for example, Class II, Class IV, Class V, Class VI, and Class VIII views.

FIG. 3 is a schematic top view of an example vehicle cabin interior.

FIG. 4 is a perspective view of an example vehicle cabin interior.

FIG. 5 is a schematic view of an example driver information display (DIS) showing vehicle operating information.

FIG. 6 is a method of a disclosed system for depicting information on the DIS.

FIG. 7 is an example DIS altered to show a captured image from the CMS.

FIG. 8 is another example DIS altered to show a captured image from the CMS.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

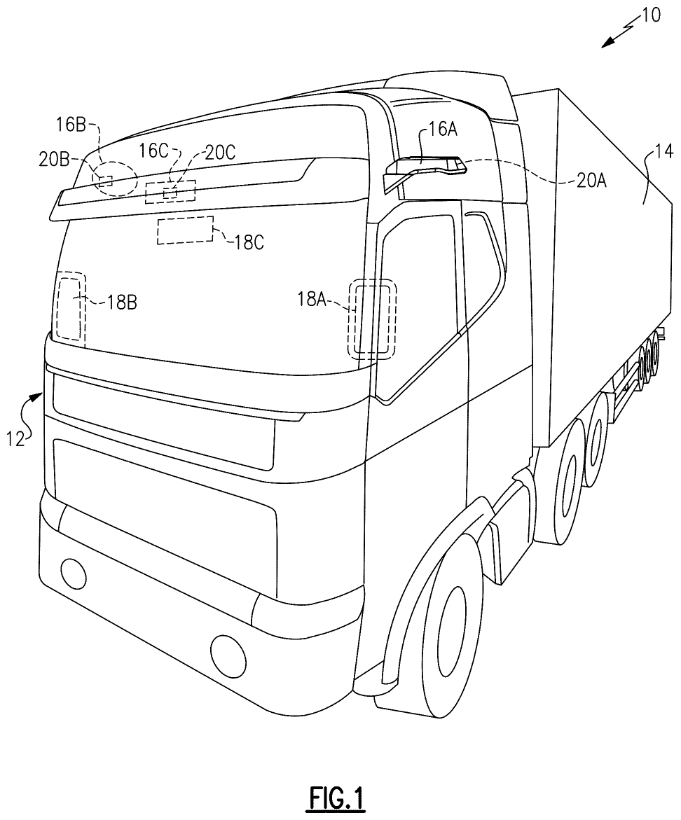

Schematic views of a commercial vehicle 10 are illustrated in FIGS. 1-4. The commercial vehicle 10 includes a vehicle cab or “tractor” 12 for pulling a trailer 14, where the trailer 14 articulates with respect to the tractor 12 during turns. Although the commercial vehicle 10 is depicted as a commercial truck with a single trailer in this disclosure, it is understood that other commercial vehicle configurations may be used (e.g., different types or quantities of trailers).

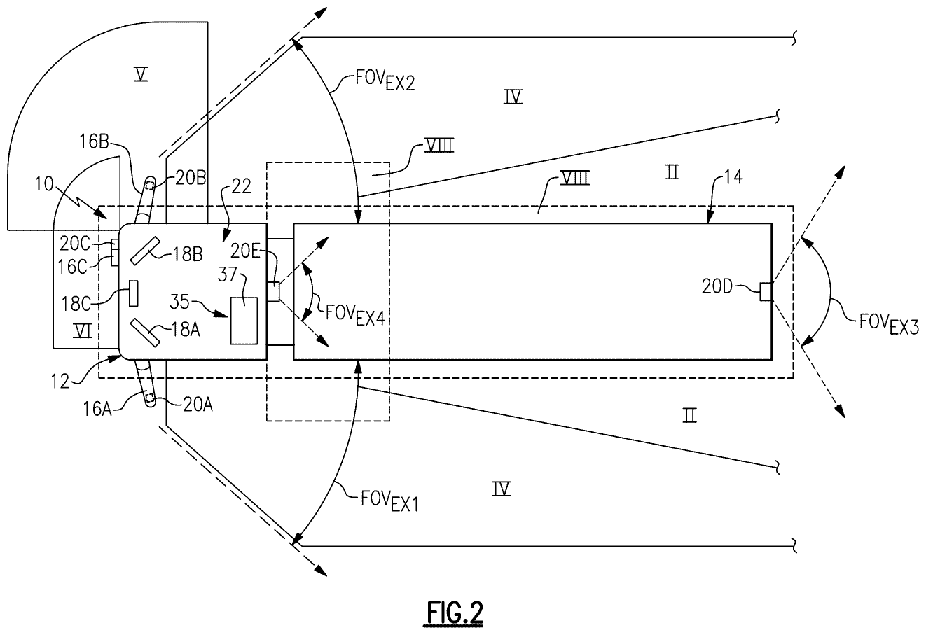

A pair of camera arms 16A-B include a respective base that is secured to, for example, the tractor 12. A pivoting arm is supported by the base and may articulate relative thereto. At least one rearward facing camera 20A-B is arranged respectively on or within the camera arms 16A-B. The exterior cameras 20A-B respectively provide an exterior field of view FOV_{EX1}, FOV_{EX2} that each include at least one of Class II and Class IV views (FIG. 2), which are legally prescribed views in the commercial trucking industry.

The Class II view on a given side of the commercial vehicle 10 is a subset of the class IV view of the same side of the commercial vehicle 10. Multiple cameras also may be used in each camera arm 16A-B to provide these views, if desired. Class II (narrow) and Class IV (wide angle) views are defined in European R46 legislation, for example, and the United States and other countries may have similar driver visibility requirements for commercial trucks. Any reference to a “Class” view is not intended to be limiting, but is intended as an example of the type of view provided to a display from a particular camera. For example, certain views may be prescribed in SAE J3155 or other regulations.

Each camera arm 16A-16B may also provide a housing that encloses electronics, e.g., a controller, that are configured to provide various features of the CMS 15. The camera arms 16A-B may be mounted either at a roof-mount location over the cab door (as shown), or on a door-mounted bracket or station, for example. If desired, the camera arms 16A-B may include conventional mirrors integrated with them as well, although the CMS 15 may be used to entirely replace mirrors. In additional examples, each side can include multiple camera arms, with each arm housing one or more cameras and/or mirrors.

If video of Class V and/or Class VI views is also desired, a camera housing 16C and camera 20C may be arranged at or near the front of the commercial vehicle 10 to provide those views (FIG. 2). Generally, Class V covers a passenger side of the vehicle from a passenger vehicle cab corner aftward along a cab of the vehicle, and Class VI covers a passenger side of the vehicle from a passenger vehicle cab corner along a front of a cab of the vehicle.

A backup camera 20D may be provided which provides a field of view FOV_{EX3}. The backup camera 20D may be mounted at a top/centerline of the trailer, at a bumper/bed level of the trailer, or at a top-corner of the back of the trailer, for example. Alternatively, or in addition to the rear trailer camera, a “fifth wheel camera” 20E may be provided that is mounted to a rear of the tractor 12 and that provides a field of view FOV_{EX4}. The fifth wheel camera 20E may be mounted anywhere between the lateral plane of the fifth wheel fixture and the top/roof edge of the tractor, for example.

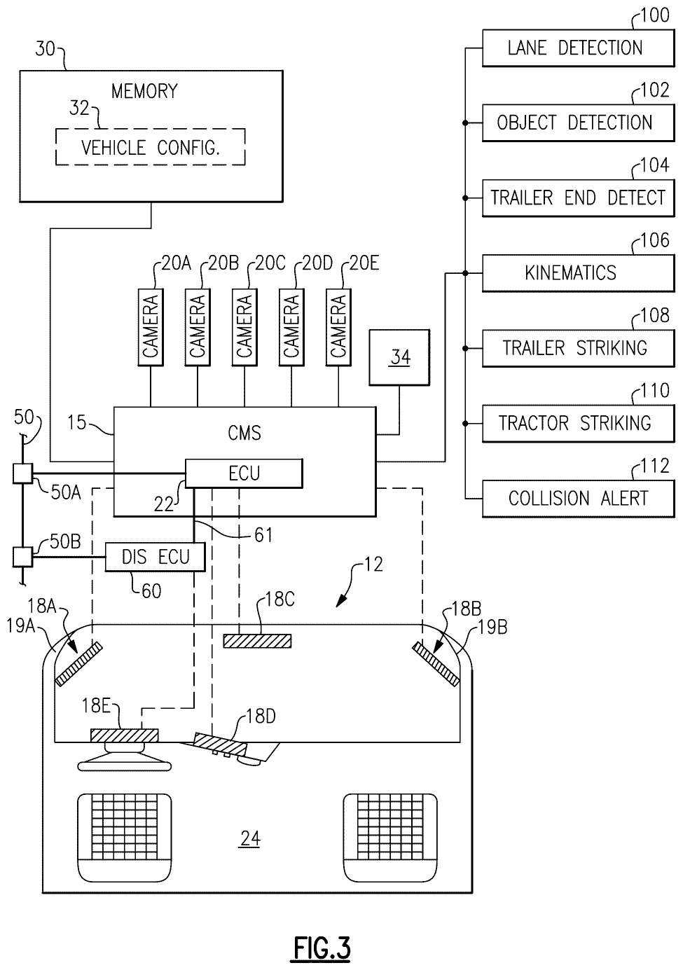

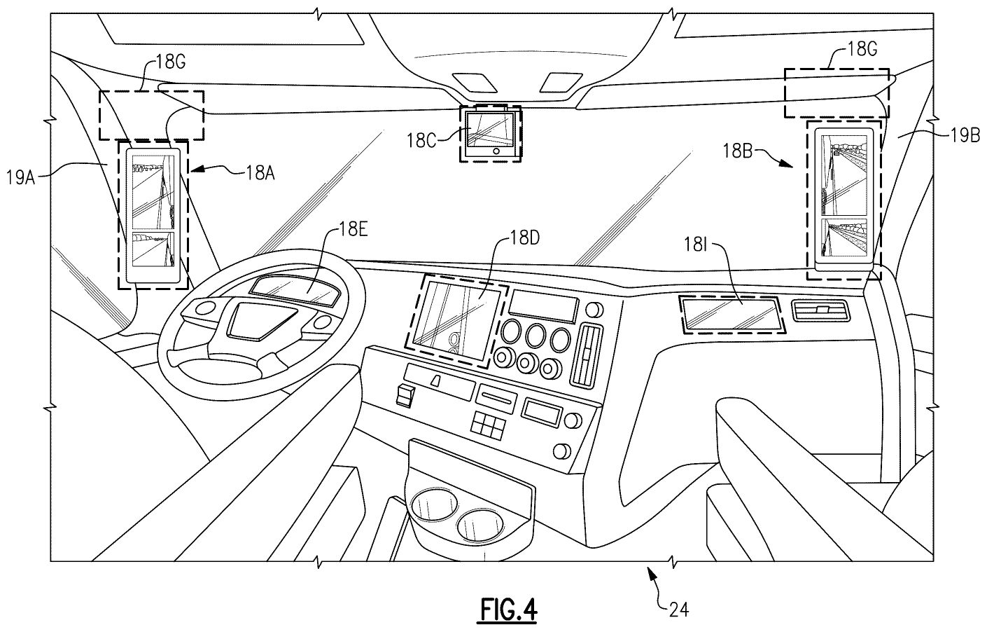

FIG. 3 is a schematic top view of an example vehicle cabin interior 24, and FIG. 4 is a perspective view of the vehicle cabin interior 24. Referring now to FIGS. 3-4 with continued reference to FIGS. 1-2, electronic displays 18A-E (e.g., which may be video displays, such as LCD displays) and cameras 20A-E are shown. The various electronic displays 18A-E and cameras 20A-E are part of a camera monitor system (CMS) 15, and therefore act as CMS displays and CMS cameras. As used herein, a “CMS camera” 20 is a camera configured to record images of an environment surrounding a commercial vehicle 10, and a “CMS display” 18 is an electronic display (e.g., an LCD) that is configured to image or display feeds from those cameras.

FIG. 4 illustrates additional or different displays 18F, 18G, 18H, 18I that may be used to display images from the cameras 20A-E or other cameras. For example, display 18F provides a heads-up-display (HUD) projected in the region of the driver side windshield. Displays 18G, 18H may be provided respectively on the A-pillars 19A, 19B to provide additional views to those of the displays 18A, 18B. An additional display 181 may be provided on the passenger side. Fewer, more or different displays and/or configurations may be used.

The CMS 15 includes a CMS controller or electronic control unit (ECU) 22 that acts as a second controller and includes processing circuitry that supports operation of the CMS 15. The CMS ECU 22 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The CMS displays 18A-B are arranged on each of the driver and passenger sides within the vehicle cab 12 on or near the A-pillars 19A-B to display Class II and Class IV views on its respective side of the commercial vehicle 10, which provide rear facing side views along the commercial vehicle 10 that are captured by the exterior cameras 20A-B.

As discussed above, if video of Class V and Class VI views are also desired, the camera housing 16C and camera 20C may be arranged at or near the front of the commercial vehicle 10 to provide those views (FIG. 2). In the example of FIG. 3, additional displays 18C-E are provided. Display 18C is arranged in the vehicle cabin interior 24 near the top center of the windshield may be used to display the Class V and Class VI views, which are toward the front of the commercial vehicle 10, or a backup camera view (from camera 20D or 20E) to the driver. Display 18D is provided in a center console area of the vehicle cabin interior 24, generally located centrally in a bottom half of the vehicle cabin, and may be used for other purposes, such as navigation, infotainment, etc (i.e., a secondary information display (SID)).

Display 18E may be part of an instrument cluster (i.e., a primary or driver information display (DIS)) located behind the steering wheel, for example. The first controller 60 is connected to the vehicle data bus 50 by a second connector 50b. The DIS 18E includes a first controller 60 and is configured to the depict vehicle operating information, such as at least one of a vehicle speed (speedometer), an engine rotational speed (tachometer), fuel level, engine temperature, and gear position indicator (PRNDL). Other example vehicle operating information such, as odometer, trip odometer, fuel economy, vehicle and/or engine maintenance information, vehicle telltales (e.g., warning lights, malfunction lights, status lights (e.g., turn signals), etc. for tractor and/or trailer).

The first and second controllers 60, 22 include domain controller functionality that authenticate and authorize requests from one another so that video from the CMS 15 can be communicated to the DIS 18E. The first and second controllers 60, 22 are connected to one another by a cable 61 other than the vehicle data bus 50 (e.g., a direct connection). The cable 61 is used to communicate video data from the second controller 22 to the first controller 60, and that video data includes captured images from one or more of the cameras 20. Example cables capable of transmitting large video data include but are not limited to Gig ethernet, 100-BaseT Ethernet and PCIE.

If video of Class VIII views is desired, camera housings can be disposed at the sides and rear of the commercial vehicle 10 to provide fields of view including some or all of the Class VIII zones of the commercial vehicle 10. In such examples, one of the displays 18C-E may include one or more frames displaying the Class VIII views. The displays 18A, 18B, 18C face a driver region 35 within the vehicle cabin interior 24 where an operator is seated on a driver seat 37.

In various examples, the ECU 22 includes one or modules having algorithm(s), equation(s) and/or decision manager(s) that receive input(s) from sensors (e.g., cameras 20A-20E, ultrasonic, LiDar, radar, etc.) and/or stored values, as schematically illustrated in FIG. 3. Example modules include Lane Detection Module 100, Object Detection Module 102, Trailer End Detection Module 104, Kinematic Module 106, Trailer Striking Area Prediction Module 108, Tractor Striking Area Prediction Module 110, and Collision Alert Module 112. Example inputs include one or more sensors 34, such as a steering angle sensor, a vehicle speed sensor, gear position sensor, and/or other sensor data. Vehicle configuration information 32, which may be stored in memory 30, relates to vehicle characteristics (e.g., trailer length, axle position, trailer type/wheelbase, tractor configuration/wheelbase, hitch point location etc.), provided by the manufacturer, operator, and/or determined by one or more of the modules. During vehicle operation, the ECU 22 may communicate information to the driver, fleet operator, or others using an output (e.g, displays 18, speaker, etc.). Example operation and uses of these modules are disclosed in International Application No. PCT/US2023/083416 filed on Dec. 11, 2023, entitled “CAMERA MONITOR SYSTEM WITH TRAILER CURB STRIKE ALERT AND TRAILER STRIKING AREA,” which is incorporated herein by reference in its entirety.

The lane detection module 100 also uses image processing of the captured images to identify markings on the roadway, such as lane markers that visually divide adjacent lanes. One example algorithm is described in United States Publication No. US2023/117,719, entitled “CAMERA MIRROR SYSTEM DISPLAY FOR COMMERCIAL VEHICLES INCLUDING SYSTEM FOR IDENTIFYING ROAD MARKINGS”, which is incorporated by reference in its entirely. In that publication, a lane detection module is described in which an object detection algorithm identifies a lane marking in a roadway by filtering a color of the lane marking from a surrounding portion of the captured image. Other techniques based upon deep learning technology or another computer vision method may be used, if desired.

The object detection module 102 includes one or more image processing algorithms configured to identify objects in the captured images. The algorithms may be used to identify VRU's (e.g., pedestrians or cyclists), attributes of the tractor 12 and/or trailer 14, other vehicles, signs, curbs, trees, buildings and/or other inanimate objects.

The trailer end detection module 104 is another image processing module that extracts one or more trailer features from the captured images to determine the location of the end of the trailer in 3D space. These extracted attributes can be used to detect objects such as tractor wheels, trailer edges and other features. Example wheel detection algorithm techniques are disclosed in United States Publication No. US2023/202,394 entitled “CAMERA MONITOR SYSTEM FOR COMMERCIAL VEHICLES INCLUDING WHEEL POSITION ESTIMATION”, which is incorporated herein by reference in its entirety. Example trailer edge detection algorithm techniques are disclosed in United States Publication No. US2023/125,045 entitled “TRAILER END TRACKING IN CAMERA MONITORING SYSTEM”, which is incorporated herein by reference in its entirety. Other techniques may be used, if desired.

In one example operation, the CMS 15 utilizes the kinematics module 106 to predict a striking zone of the trailer 14 during a turn operation and generates a two-dimensional overlay to digitally impose over at least one of the displayed Class II/IV images thereby showing the vehicle operator an expected striking zone of the trailer 14 and allowing the vehicle operator adjust the vehicle operations accordingly. The CMS 15 uses the received captured images from the cameras 20A, 20B, as well as any other cameras and vehicle operation data received from a general vehicle controller through a data connection, such as a CAN or LIN bus, to estimate a predicted position of the tractor and/or trailer side at each of multiple side positions and multiple points in time. These positions are converted to a geometric area encompassing all the positions. In this way, the shape and size of the geometric area is not fixed, but rather reflects an actual predicted striking area of the trailer.

In order to avoid accidental strikes, the striking area prediction system uses the vehicle data (e.g. steering angle, steering rate, trailer angle, vehicle speed, trailer wheelbase, tractor wheelbase, hitch point location, yaw rate and the like) to generate a predicted striking zone over time. The predicted striking zone is a prediction of the path the trailer will take over the course of the turn and is re-calculated continuously as the turn progresses. The trailer striking area is also useful in a potential “curve cut” scenario when the vehicle 10 is traveling down a curved roadway. In a curvy road, it becomes more likely for the trailer end to cross the lane markers. indicating boundaries to adjacent lanes, creating a potentially dangerous situation.

The CMS 15 includes a Decision Manager or Collision Alert Module 112 that communicates with the modules 100-110 to evaluate the proximity between the predicted tractor and/or trailer paths (i.e., the tractor and trailer striking areas) and one or more objects (e.g., predicting an imminent curb strike, curve cut, object collision etc.). The decision manager considers the estimated time to the event, severity (what the object is), closing rate between objects, etc. and may provide an overlay and/or alert.

While various overlays and alerts may useful in increasing operator awareness and enhancing safety, it is desirable to more easily and proactively manage awareness of vehicle surroundings. The disclosed CMS/DIS architecture and DIS functionality provides improved operator awareness while minimizing distractions.

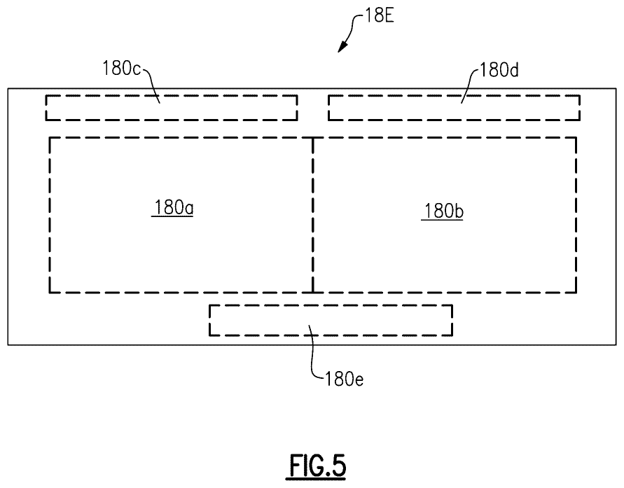

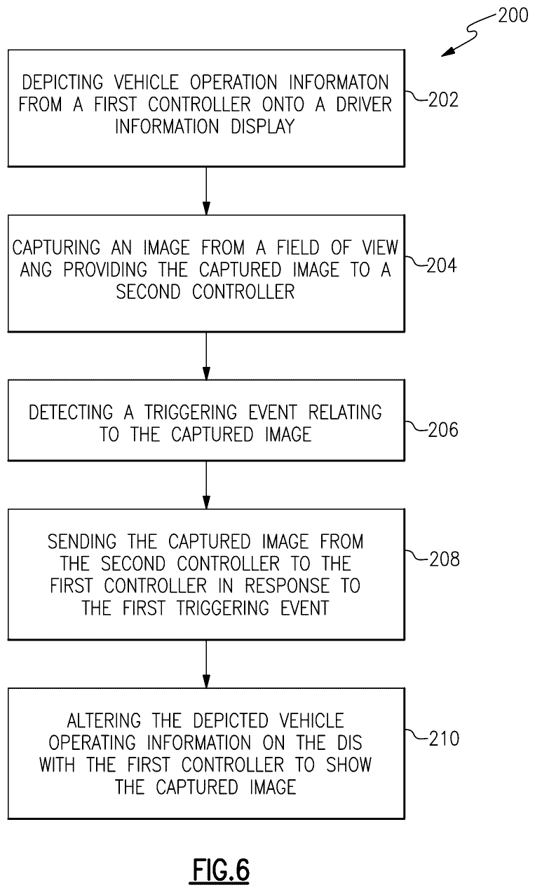

A highly schematic example DIS 18E is shown in FIG. 5, and a method 200 of displaying information to the DIS 18E is illustrated in FIG. 6. The DIS 18E has multiple display areas (e.g., 180a-180e) configured to depict the vehicle operating information to the operator, as shown in block 202 in FIG. 6. In the example, there are at least two main display areas 180a, 180b arranged laterally on the DIS 18E that display such information as vehicle speed and engine RPM. Display areas 180c, 180d may display such information as turn signals, tell tales, malfunctions, warnings or other information typically conveyed by icons. Display area 180e may display information such as odometer and trip odometer information. Of course, the display areas may be configured differently than shown and may be used to display additional or different vehicle operating information.

Since the first and second controllers 60, 22 are configured to communicate with one another, the CMS controller 22 can send video data (block 208) to the DIS controller 60 to display a live video stream containing captured images from one or more of the cameras 20 (block 204) when doing so would be beneficial to the operator (e.g., change in vehicle operating condition and/or heighted awareness needed in an area outside the vehicle 10; i.e., a triggering event; block 206). To this end, captured images from the second controller 22 are sent to the first controller 60 over the cable 61 in response to the triggering event. The first controller 60 then alters the depicted vehicle operating information (block 210) in one or more of the display areas 180a-180e on the DIS 18E to show the captured images from the camera(s) 20. Some information on the DIS 18E may not be altered based upon regulations or OEM requirements (e.g., vehicle speed, fuel level, gear position), but other displayed information on the DIS 18E may be subject to alteration.

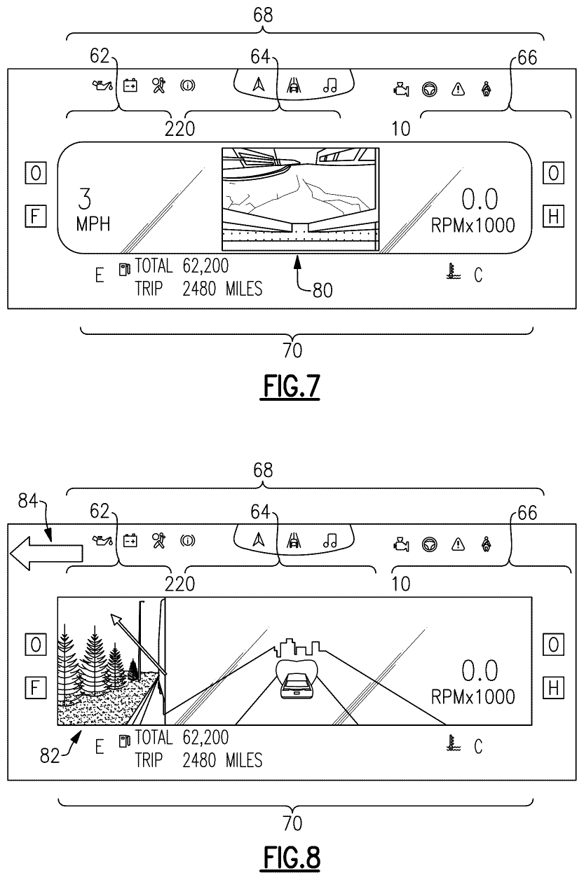

The triggering event is detected by at least one of the first and second controllers 60, 22 based upon information received from the vehicle data bus 50 (e.g., transmission gear change, brake switch, turn signal, etc). Several example DIS displays which have been altered to display a captured image from the CMS controller 22 are shown in FIGS. 7 and 8. The DIS has main vehicle operating information areas 62, 64, 66 and secondary vehicle operating information areas 68, 70, which may show tell tales or other information. The DIS display areas may be configured in manner other than illustrated.

In the example shown in FIG. 7, the triggering event includes a change in transmission gear position, which is sent over the vehicle communications bus 50. When the transmission is in reverse, it is desirable to provide the video 80 from trailer camera 20D (or from camera 20E without trailer) to provide visibility in what would otherwise be a blind spot. The rear trailer video 80 is displayed centrally on the DIS 18E in display area 64, which is an intuitive placement (central) in relation to the source of the video (central to the vehicle 10).

In the example shown in FIG. 8, the triggering event is a turn signal indicator status 84, for example, from the left side of the vehicle 10, In this example, video from the left side tractor camera 20A is provided in the left side display area 180a of the DIS 18E.

In another example, the triggering event may be the result of an object detection from the object detection module 102, for example. The object detection module 102 may detect a vulnerable road user (VRU) and a non-VRU in the field of view and which it is desirable to get the attention of the operator (e.g., too close to vehicle 10). In such an instance, one or more of the display areas on the DIS 18E may be altered to show the captured image having the VRU/non-VRU, which may be displayed on the side of the DIS 18E corresponding to the side of the vehicle 10 where the VRU/non-VRU is located (e.g., VRU detected by camera 20A on left side will be displayed on left side of DIS 18E).

The display area that has been swapped or otherwise modified to show the captured images provided by the CMS controller 22 may revert back to its original configuration in response to another triggering event. The may occur if there is a change in vehicle operational state (e.g., change in gear, change in vehicle speed, change in steering angle). Additionally or alternatively, the other triggering event is a predetermined elapse of time (e.g., 15 seconds).

While one aspect of the disclosed system and method has been described relative to the first and second controller configuration, it should be understood that the display of DIS 18E may be altered in a similar manner with different system architectures. The method of DIS operation includes depicting vehicle operating information onto a driver information display (DIS), capturing the image from a field of view, detecting a triggering event relating to the captured image, and altering the depicted vehicle operating information on the DIS to show the captured image.

The disclosed DIS functionality enables the operator to more readily assimilate important changes in operating conditions, for example, by displaying a trailer rear view and/or side views in a just in time manner generally where the operator's eyes are directed. That is, the SID 18D is typically located lower than the DIS 18E and in a location that tends to take the operator's eyes away from the viewing areas surrounding the vehicle. Having this functionality in the DIS 18E can eliminate the use of and/or need for a secondary information display, providing a lower cost system due to the SID 18D being omitted from the CMS.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of providing views in a camera monitor system (CMS) for a vehicle, comprising:
a) depicting vehicle operating information from a first controller onto a driver information display (DIS), wherein the depicting step includes showing at least one of a vehicle speed, an engine rotational speed, fuel level, engine temperature, and gear position indicator;
b) capturing an image from a field of view and providing the captured image to a second controller;
c) detecting a triggering event relating to the captured image;
d) sending the captured image from the second controller to the first controller in response to the triggering event; and
e) altering the depicted vehicle operating information on the DIS with the first controller to show the captured image.

2. The method of claim 1, wherein the DIS has multiple display areas configured to depict the vehicle operating information, and the altering step swaps the captured image for the depicted vehicle operating information in at least one of the multiple display areas.

3. The method of claim 2, wherein the multiple display areas are arranged laterally on the DIS, and the altering step includes swapping the captured image for the at least one of the multiple display areas associated with a vehicle side from which the captured image originates.

4. The method of claim 1, wherein the first and second controllers are each domain controllers that are connected to a vehicle data bus, and the first and second controllers are connected to one another by a cable other than the vehicle data bus which communicates video data that includes the captured image.

5. The method of claim 4, wherein the detecting step includes one of the first and second controllers receiving the triggering event over the vehicle data bus.

6. The method of claim 5, wherein the triggering event includes a transmission gear position, and the captured image provides a rearward view from a trailer camera in communication with the second controller.

7. The method of claim 5, wherein the triggering event includes a turn signal indicator status from one side of a vehicle, and the captured image provides rearward view from a tractor camera on the one side, the tractor camera in communication with the second controller.

8. The method of claim 1, wherein the triggering event includes detecting at least one of a vulnerable road user (VRU) and a non-VRU in the field of view, and the altering step includes showing the captured image having the at least one VRU and non-VRU.

9. A camera monitor system (CMS), comprising:
a driver information display (DIS) having a first controller and configured to depict vehicle driver information that shows at least one of a vehicle speed, an engine rotational speed, fuel level, engine temperature, and gear position indicator;
multiple cameras configured to capture multiple fields of view in proximity to a commercial vehicle, at least one of the multiple fields of view including a captured image;
multiple displays other than the DIS that are configured to display images from the captured multiple fields of view, the multiple displays configured to each illustrate a displayed field of view from the multiple fields of view;
a second controller in communication with the multiple cameras and the multiple displays, the second controller configured to send the captured image to the first controller in response to a triggering event relating to the captured image; and
wherein the first controller is configured to alter the depicted vehicle operating information on the DIS to show the captured image.

10. The method of claim 9, wherein the DIS has multiple display areas configured to depict the vehicle operating information, and the second controller is configured to alter the depicted vehicle operating information by swapping the captured image for the depicted vehicle operating information in at least one of the multiple display areas, wherein the multiple display areas are arranged laterally on the DIS, and the altering step includes swapping the captured image for the at least one of the multiple display areas associated with a vehicle side from which the captured image originates.

11. The method of claim 9, wherein the first and second controllers are each domain controllers that are connected to a vehicle data bus, and the first and second controllers are connected to one another by a cable other than the vehicle data bus which communicates video data that includes the captured image.

12. The method of claim 11, wherein one of the first and second controllers are configured to receive the triggering event over the vehicle data bus.

13. The method of claim 12, wherein the triggering event includes a transmission gear position, the multiple cameras include a trailer camera, and the captured image provides a rearward view from the trailer camera.

14. The method of claim 12, wherein the triggering event includes a turn signal indicator status from one side of a vehicle, the multiple cameras include a tractor camera and the captured image provides rearward view from the tractor camera on the one side.

15. The method of claim 9, wherein the triggering event includes detecting at least one of a vulnerable road user (VRU) and a non-VRU in the field of view, and the altering step includes showing the captured image having the at least one VRU and non-VRU.

16. A method of providing views in a camera monitor system (CMS) for a vehicle, comprising:
a) depicting vehicle operating information onto a driver information display (DIS), wherein the depicting step includes showing at least one of a vehicle speed and an engine rotational speed;
b) capturing an image from a field of view;
c) detecting a triggering event relating to the captured image; and
d) altering the depicted vehicle operating information on the DIS to show the captured image.

17. The method of claim 16, wherein the DIS has multiple display areas configured to depict the vehicle operating information, and the altering step swaps the captured image for the depicted vehicle operating information in at least one of the multiple display areas, wherein the multiple display areas are arranged laterally on the DIS, and the altering step includes swapping the captured image for the at least one of the multiple display areas associated with a vehicle side from which the captured image originates.

18. The method of claim 16, wherein the triggering event includes a transmission gear position, and the captured image provides a rearward view from a trailer camera.

19. The method of claim 16, wherein the triggering event includes a turn signal indicator status from one side of a vehicle, and the captured image provides rearward view from a tractor camera on the one side.

20. The method of claim 16, wherein the triggering event includes detecting at least one of a vulnerable road user (VRU) and a non-VRU in the field of view, and the altering step includes showing the captured image having the at least one VRU and non-VRU.
